(19) United States
(12) Patent Application Publication
(10) Pub. No.: US 2025/0252594 A1
(43) Pub. Date: Aug. 7, 2025

(54) OPERATOR AND OCCUPANT MONITORING VALIDATION FOR AUTONOMOUS AND SEMI AUTONOMOUS MACHINES

(71) Applicant: NVIDIA Corporation, Santa Clara, CA (US)

(72) Inventors: Richard Bramley, Santa Clara, CA (US); Niranjan Avadhanam, Saratoga, CA (US); Nishant Puri, San Francisco, CA (US); Rajath Shetty, Sunnyvale, CA (US); Prashant Chandrasekhar, San Ramon, CA (US)

(21) Appl. No.: 18/435,897

(22) Filed: Feb. 7, 2024

(51) Int. Cl. G06T 7/70; G06V 40/16; G06V 40/20

(52) U.S. Cl. CPC G06T 7/70; G06V 40/167; G06V 40/20

(57) ABSTRACT

In various examples, one or more validity checks that model one or more aspects of human physiology may be applied to frames of detected human features to detect and respond to the presence of faults. Example validity checks include human feature constraints derived from the kinematics of human motion, anatomical and spatial constraints, consistency across detection modalities, and/or others. The present techniques may be utilized to validate human features detected by various computer vision tasks, such as those involving pose estimation, facial detection, gesture recognition, and/or activity monitoring, to name a few examples.

### BACKGROUND

The human body is often characterized by a set of keypoints, each representing specific anatomical landmarks or joints that may be used to represent body posture or movement. The relevant keypoints may depend on the task, and may include facial landmarks such as the eyes (corners and pupils), nose (nostrils and tip), mouth (corners and center), and eyebrows, major joints such as the shoulders, elbows, wrists, hips, knees, and ankles, and/or other anatomical landmarks. A varying selection of these and other keypoints are detected, monitored, and/or tracked when performing a number of computer vision tasks such as pose estimation, face detection, gesture recognition, and activity monitoring, which in turn can be used for more advanced or sophisticated applications. For example, pose estimation has applications in fields like healthcare for physical rehabilitation assessment, sports analytics for performance optimization, and biomechanics for studying human movements. Security systems leverage human keypoints for surveillance and tracking of individuals within monitored areas. Some human-computer interaction interfaces use keypoint detection, enabling gesture recognition and facilitating natural and intuitive interactions. The entertainment and gaming industries use keypoint tracking for motion capture, translating real-world movements into generated scenes of virtual environments. More generally, there are a variety of computer vision tasks that rely on detection, monitoring, or tracking of human features (e.g., keypoints, gaze, pose, drowsiness, gestures, etc.), whether or not those features derive from detected keypoints. For example, a gaze, pose, gesture, and/or drowsiness level may be derived from detected keypoints or directly predicted without the use of keypoints.

One application in which keypoints and other detected human features may be used is in autonomous vehicles. For example, detected keypoints and/or poses may be used to monitor pedestrians, anticipate pedestrian movements, and identify and avoid potential intersections with the driving path, helping the autonomous vehicle to navigate safely through complex driving environments. In another example, in-cabin or cockpit monitoring systems such as a driver monitoring system (DMS) may use keypoints to assess or may directly assess driver attentiveness, gaze direction, and/or hand movements in order to detect and mitigate signs of driver distraction, fatigue, and/or drowsiness. Occupant monitoring systems (OMS) may use keypoints to assess or may directly assess occupant positions, movements, and/or hand gestures for various reasons such as adjusting airbag deployment or detecting potentially unsafe behavior.

Advanced driver assistance systems (ADAS) are used in modern vehicles to enhance safety, improve driving performance, and provide a more comfortable and efficient driving experience. An ADAS may employ various automation features such as adaptive cruise control, lane departure warning and assist, and automatic emergency braking. The Society of Automotive Engineers (SAE) J3016 standard defines various levels of driving automation including level 2 (L2) and level 3 (L3). L2 represents partial automation, in which the vehicle can assist with both steering and acceleration or deceleration, but the driver is required to remain engaged and monitor the driving environment at all times. In L2 mode, features like adaptive cruise control and lane-keeping assistance may be active, providing a level of hands-free driving assistance. L3 represents conditional automation, where the vehicle is capable of handling all aspects of driving under specific conditions and environments without continuous monitoring by the driver. However, the driver must still be present in the driver's seat and be ready to take over control if prompted by the system. As such, a DMS often plays a pivotal role in controlling the activation, operation, and/or deactivation of different automation levels, as the DMS ensures that the driver remains engaged and/or ready to resume control when required.

Automotive Safety Integrity Level (ASIL) is a risk classification system defined by ISO 26262 and used in the automotive industry to assess the safety and reliability of electronic systems and components. ASIL categorizes potential hazards associated with automotive functions based on their impact on overall safety. ASIL defines four levels: ASIL A, ASIL B, ASIL C, and ASIL D, each representing a progressively higher level of safety guidelines. Each ASIL level defines safety goals and objectives that must be met to mitigate the identified risks. The higher the ASIL level, the more rigorous the verification and validation processes become. Higher ASIL levels necessitate more stringent development processes and fault coverage for both hardware and software components to ensure they meet the specified safety requirements. Systems with higher ASIL levels typically require greater fault tolerance and diagnostic coverage to ensure the system can detect and mitigate faults that could lead to hazardous situations. The highest level—ASIL D—is assigned to functions with the most critical safety requirements, necessitating the most rigorous development and testing processes.

A DMS that controls activation, operation, and/or deactivation of autonomous driving systems must work in conjunction with those systems to meet the overall safety goals, which can range from ASIL A to ASIL D. An ASIL-rated DMS typically requires robust fault tolerance mechanisms and high diagnostic coverage to ensure reliability and safety. For example, diagnostic coverage may quantify a DMS's ability to detect and respond to faults in various elements of its pipeline (e.g., sensors, processors, communication interfaces). Conventionally, ASIL-rated DMS developers use built-in hardware tests and continuous monitoring to comply with ASIL ratings. For example, built-in hardware tests may monitor and test sensors such as cameras or infrared sensors for proper alignment, calibration, or the absence of physical damage, may monitor and test processing units to assess computational integrity or memory functionality, and/or may monitor and test communication interfaces for data integrity. However, relying on built-in hardware, self-testing, and/or continuous monitoring requires hardware and software resources, imposing computational demands and constraints on the footprint and thermal performance of the hardware. For these and other reasons, there is a need for improved techniques for detecting, monitoring, and/or tracking human features in computer vision tasks, such as driver monitoring.

### SUMMARY

Embodiments of the present disclosure relate to validity checks for detection, monitoring, and/or tracking of human (e.g., machine-occupant) features. Systems and methods are disclosed that apply one or more validity checks that model one or more aspects of human physiology to frames of detected human features to detect and respond to the presence of faults.

In contrast to conventional systems, such as those described above, one or more detected human features (e.g., keypoint(s), gaze, pose, drowsiness, gesture, joint angle, limb length, shape, presence, etc.) may be extracted from sensor data, and one or more validity (e.g., plausibility) checks that model one or more aspects of human physiology may be run on the detected human feature(s) to verify their validity. Example validity checks may be modeled on the kinematics of human motion, anatomical constraints the human body imposes on joint angles and/or plausible limb lengths, spatial constraints such as those that are external to the human body, and/or consistency across detection modalities, to name a few examples. As such, the validity check(s) may serve to detect the presence of faults, and any suitable responsive action may be taken (e.g., temporarily disabling specific functionalities, rerouting tasks to redundant or alternative components that provide similar functionality, generating a log entry capturing relevant information, etc.).

The present techniques may be used in a variety of applications. Taking a DMS used to control the activation, operation, and/or deactivation of an autonomous driving (e.g., L2, L3) feature as an example, one or more validity checks may be performed on one or more outputs generated by the DMS. Example DMS validity checks may include comparing sensor inputs with designated limits on an expected range of motion of a detected head pose and/or gaze direction, one or more limits on expected changes in a detected head pose and/or gaze direction (e.g., from frame to frame), one or more limits on the expected time between detected blinks, one or more limits on expected changes in a detected measure of drowsiness, etc. In some embodiments, one or more components of a DMS pipeline (e.g., sensor(s), processors, chips, etc.) may be executed on hardware that is not ASIL-rated, and one or more validity checks on the DMS may be executed on ASIL-rated hardware (e.g., whether or not on a chip that controls the activation, operation, and/or deactivation of the autonomous driving feature based on the validity check(s)). Validating the DMS output on ASIL-rated hardware obviates the need for at least some built-in hardware tests and/or continuous monitoring in the DMS pipeline, reducing and even eliminating the need for corresponding built-in hardware, alleviating constraints on the footprint and thermal performance of the remaining hardware, and freeing up computational resources for other tasks such as running the DMS at a higher frame rate and monitoring the environment at times when prior designs were performing self-testing.

### BRIEF DESCRIPTION OF THE DRAWINGS

The present systems and methods for validity checks for detection, monitoring, and/or tracking of human features are described in detail below with reference to the attached drawing figures, wherein:

FIG. 1 is a data flow diagram illustrating an example human feature detection pipeline with validity checks, in accordance with some embodiments of the present disclosure;

FIG. 2 is a data flow diagram illustrating an example advanced driver assistance control system with validity checks, in accordance with some embodiments of the present disclosure;

FIG. 3 is a flow diagram showing a method for identifying faults based at least on one or more validity checks, in accordance with some embodiments of the present disclosure;

FIG. 4 is a flow diagram showing a method for executing one or more validity checks on a set of safety or reliability rated processor(s), in accordance with some embodiments of the present disclosure;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

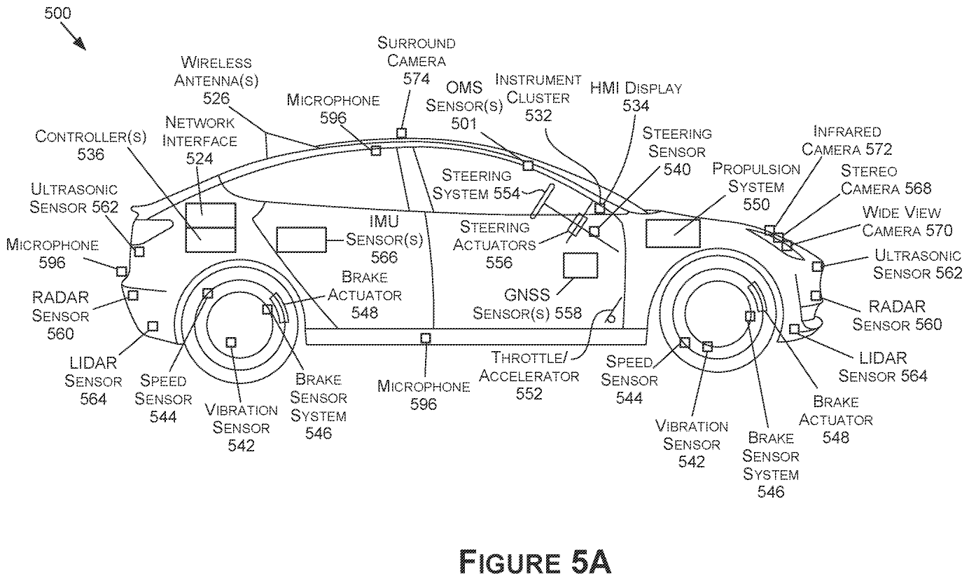

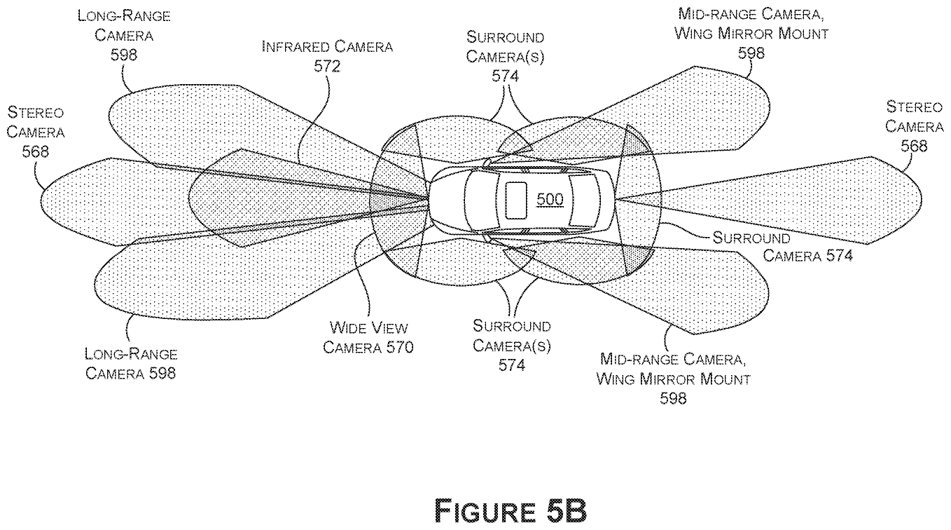

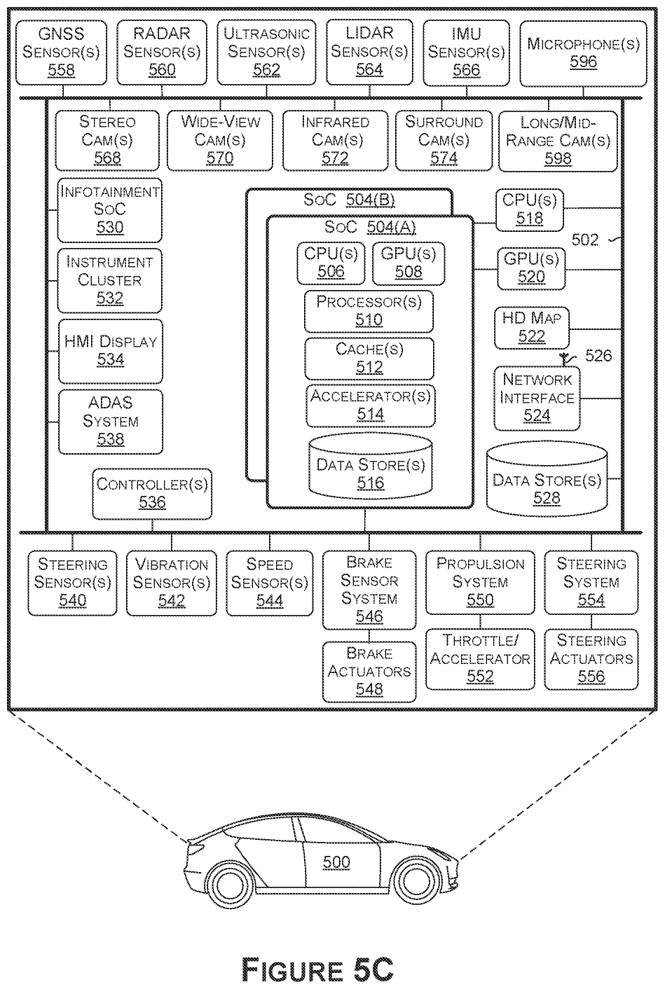

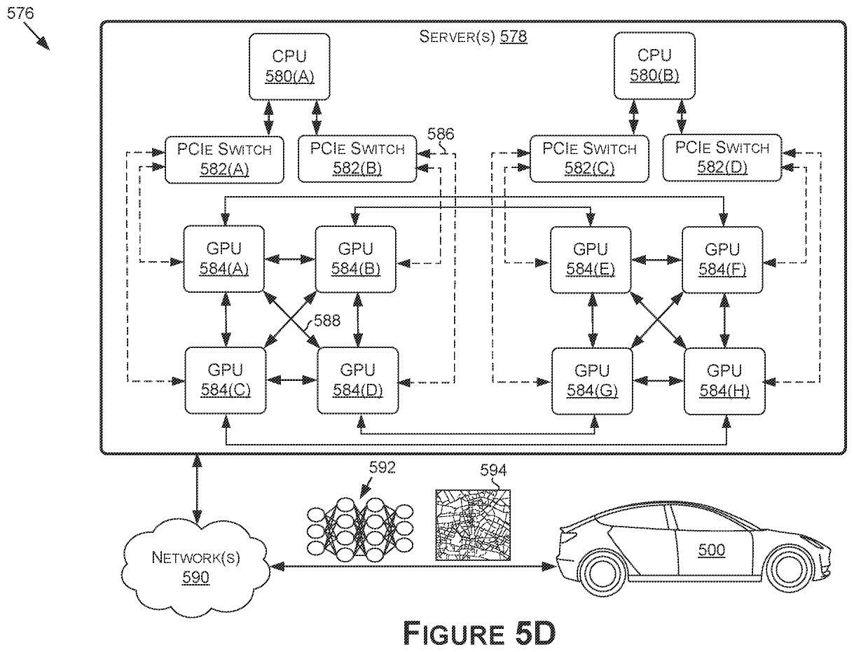

Systems and methods are disclosed relating to validity checks for detection, monitoring, and/or tracking of features of a human occupant (e.g., of a vehicle or other machine). Although the present disclosure may be described with respect to an example autonomous or semi-autonomous vehicle or machine 500 (alternatively referred to herein as “vehicle 500” or “ego-machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to an operator or occupant monitoring system (e.g., a DMS or OMS), this is not intended to be limiting, and the systems and methods described herein may be used in computer vision (e.g., pose estimation, face detection, gesture recognition, activity monitoring), robotics, security and surveillance, autonomous or semi-autonomous machine applications, augmented reality, virtual reality, mixed reality, and/or any other technology spaces where detected human features may be used.

In some embodiments, one or more validity checks that model one or more aspects of human physiology may be applied to frames of detected human features to detect and respond to the presence of faults. Example validity checks include human feature constraints derived from the kinematics of human motion, anatomical and spatial constraints, consistency across detection modalities, and/or others. The present techniques may be utilized to validate human features detected by various computer vision tasks, such as those involving pose estimation, facial detection, gesture recognition, and/or activity monitoring, to name a few examples. In an example embodiment involving the use of a DMS to control the activation, operation, and/or deactivation of autonomous driving (e.g., L2, L3), the validity checks may be performed on ASIL-rated hardware, enabling one or more components of the DMS pipeline to run on hardware that need not be ASIL-rated, obviating the need for at least some built-in hardware tests and/or continuous monitoring. In an example embodiment involving a monitoring and collision avoidance pipeline that monitors and avoids pedestrians or vulnerable road users, the validity checks may be performed on ASIL-rated hardware, enabling one or more components of the monitoring and collision avoidance pipeline to run on hardware that need not be ASIL-rated or on hardware with a lower ASIL rating, obviating the need for at least some built-in hardware tests and/or continuous monitoring.

In some embodiments, one or more validity checks on detected human features (e.g., keypoints, poses) may be modeled on the kinematics of human motion. For example, temporal consistency and/or limits on the velocity or acceleration of human joints may impose constraints on plausible locations of detected human keypoints. Taking an application that monitors a driver's face (using a DMS camera) as an example, at any given frame rate (e.g., 15 frames per second (fps)), based on physiological constraints, the driver should not be able to rotate their head more than some angular threshold (e.g., 45 degrees) or move their head by more than some displacement threshold (e.g., 50 centimeters) from frame to frame (e.g., in 66 milliseconds). In some embodiments, a (e.g., physiologically-derived) limit on expected keypoint, joint, or pose velocity and/or acceleration may be used to derive a corresponding threshold change in 2D or 3D position (spatial displacement), joint angle (angular displacement), and/or otherwise. As such, 2D pixel positions and/or 3D positions of human keypoints or poses may be detected from each frame of sensor data, and one or more keypoint or pose changes may be monitored from frame to frame (e.g., changes in 2D and/or 3D position, change in joint angle). Changes in detected keypoints or poses that exceed a designated threshold based on body kinematics may be identified as errors.

In some embodiments, one or more validity checks on detected human features (e.g., keypoints, poses, limb length) may be modeled on one or more anatomical constraints the human body imposes on joint angles and/or plausible limb lengths. For example, some joints like elbows and knees cannot move in all directions. Knees may be able to extend to about 0 degrees when fully straightened, and may bend up to 135 or 140 degrees. Elbows may be able to extend to about 0 degrees when fully straightened, and may bend up to 145 or 160 degrees. Furthermore, limb lengths in humans may be modeled within a finite expected range. In some embodiments, any known age estimation technique may be used (e.g., predicted based on facial attributes) to further limit the range of plausible limb lengths. Additionally or alternatively to limits on absolute limb length derived from in a particular frame, detected limb length may be expected to not change substantially from frame to frame (e.g., in the absence of seating changes), so a threshold may be derived for a maximum expected change in detected limb length from frame to frame. In another example, one or more validity checks may be modeled on spatial constraints the human body imposes on relative positions of keypoints and/or corresponding poses. For example, superposition of certain keypoints is impossible (e.g., the hand or neck cannot be inside the torso). As such, detected human features that exceed a designated threshold on detected joint angles, detected limb lengths, changes in detected limb lengths, or relative positions of detected body parts may be may be identified as errors.

In some embodiments, one or more validity checks on detected human features (e.g., keypoints, poses) may be modeled on spatial constraints such as those that are external to the human body. In some embodiments, one or more spatial constraints may be derived from a monitored context. In a DMS for example, the driver should be sitting in a seat, so the knee joint should not typically be able to extend to a fully straightened position. While driving, depending on the design on the vehicle, chair position, and/or other considerations, the driver's knee joint may be able to extend up to 45 degrees (e.g., when operating pedals) and may bend up to 90 or 120 degrees. Other physical contexts may have other anticipated spatial constraints. As such, corresponding thresholds in 2D or 3D positions of, distance between, and/or angle represented by corresponding detected keypoints or poses may be derived, and detected keypoints or poses that exceed a designated threshold imposed by one or more spatial constraints that are external to the human body may be may be identified as errors.

In some embodiments, one or more validity checks on detected human features (e.g., keypoints, gaze, pose, drowsiness, gestures) may be modeled on consistency across detection modalities. For example, multiple cameras (e.g., a DMS and OMS camera) may be used to monitor the same person, detected (e.g., 3D) positions of corresponding keypoints detected using the different cameras may be verified against one another, and corresponding detected keypoint that exceed a designated threshold in (e.g., 3D) position may be identified as errors in either processing pipeline, both processing pipelines, and/or a common path shared by both processing pipelines. In some embodiments, a pose, gesture, or other human feature detected using one sensor or processing pipeline may be verified against a corresponding feature detected using a different sensor or processing pipeline. For example, cross checks may be performed across concurrent human monitoring systems (e.g., the presence of and/or keypoints of a face detect from a DMS may be cross checked against the presence of and/or keypoints of a face or person detect from an OMS), and/or between a human monitoring system and a non-human monitoring system (e.g., a detected change in steering angle may be cross checked against a detected hand gesture representing a classification that both hands are off the steering wheel). In another example, RADAR data representing body pose or movement may be correlated with a corresponding body pose or movement detected by a DMS or OMS to cross check corresponding detected keypoint or pose positions and verify sensor and/or pipeline health. These are just a few examples, and other types of cross-checks across detection modalities are contemplated within the scope of the present disclosure.

Taking a DMS used to control the activation, operation, and/or deactivation of an autonomous driving (e.g., L2, L3) feature as an example, one or more validity checks may be performed on one or more outputs generated by the DMS. Example DMS validity checks may include designated plausible limits on the range of motion of a detected head pose and/or gaze direction, changes in detected head pose and/or gaze direction from frame to frame, designated plausible limits on the time between detected blinks, designated plausible limits on changes in a detected measure of drowsiness (e.g., an assigned Karolinska Sleepiness Scale (KSS) value should not change from 1-5 to 7-9 or vice versa from frame to frame), etc.

In some embodiments, one or more components of the DMS pipeline (e.g., sensor(s), processors, chips, etc.) may be executed on hardware that is not ASIL-rated, and one or more validity checks on the DMS may be executed on ASIL-rated hardware (e.g., whether or not on a chip that controls the activation, operation, and/or deactivation of an autonomous driving feature based on the validity check(s)). In some embodiments, results of and/or data used by any given validity check may be averaged over some number of frames, and errors may be computed based on averaged data and/or flagged based on averaged results. If one or more validity checks detect a fault in a DMS output, the DMS may be deemed inoperative, and one or more responsive actions may be executed. For example, autonomous driving may be disengaged, the driver or operator may be given some advanced warning (e.g., 10 seconds) prior to disengaging autonomous driving, one or more emergent driving maneuvers may be executed (e.g., the autonomous vehicle may perform an emergency stop), and/or other actions. Validating the DMS output on ASIL-rated hardware obviates the need for at least some built-in hardware tests and/or continuous monitoring in the DMS pipeline, reducing and even eliminating the need for corresponding built-in hardware, alleviating constraints on the footprint and thermal performance of the remaining hardware, and freeing up computational resources for other tasks such as running the DMS at a higher frame rate and monitoring the environment at times when prior designs were performing self-testing.

In some embodiments, one or more components of a monitoring and collision avoidance pipeline (e.g., sensor(s), processors, chips, etc.) may be executed on hardware that is not ASIL-rated to detect keypoints and/or poses of pedestrians or other vulnerable road users, and one or more validity checks on the detected keypoints and/or poses may be executed on ASIL-rated hardware (e.g., whether or not on a chip that performs intent recognition, trajectory prediction, path planning, and/or avoidance based on the validity check(s)). In some embodiments, results of and/or data used by any given validity check may be averaged over some number of frames, and errors may be computed based on averaged data and/or flagged based on averaged results. If one or more validity checks detect a fault in one of the outputs of the monitoring and collision avoidance pipeline, the component and/or pipeline may be deemed inoperative, and one or more responsive actions may be executed (e.g., emergency braking, safe stop and park, handover to manual control, failure reporting, etc.). As with other possible use cases, validating the output of an upstream component of an ASIL-rated pipeline on downstream ASIL-rated hardware obviates the need for at least some built-in hardware tests and/or continuous monitoring in the pipeline.

As such, the techniques described herein may be utilized to validate detected human features in computer vision tasks such as driver or occupant monitoring, and/or others that involve pose estimation, face detection, gesture recognition, and/or activity monitoring.

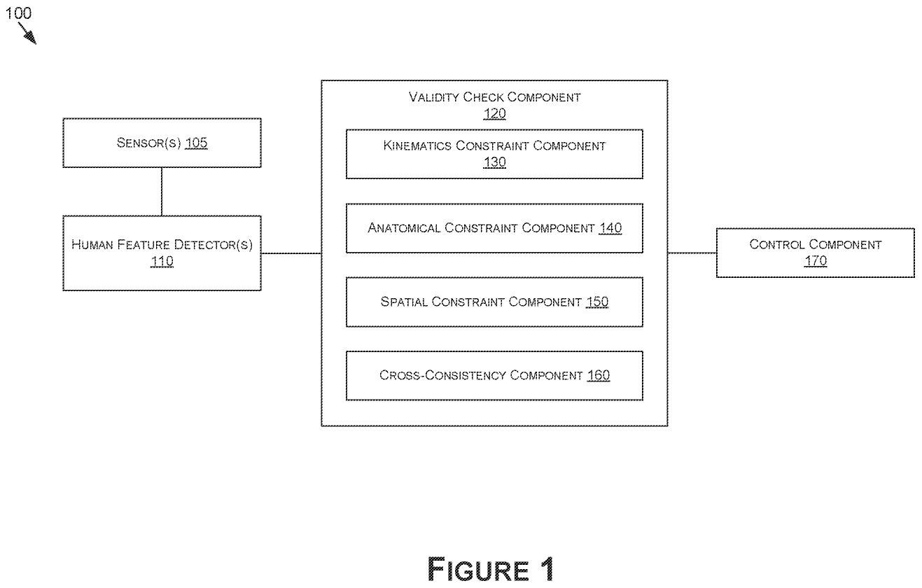

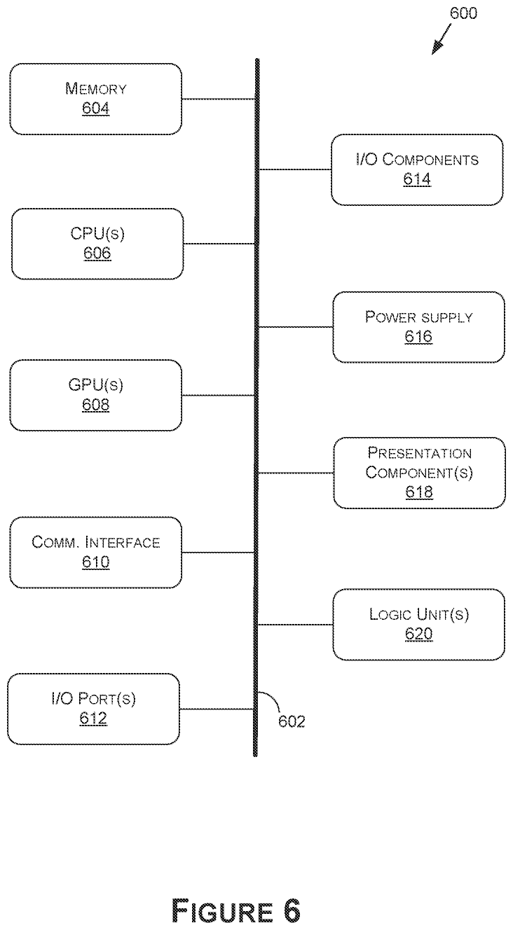

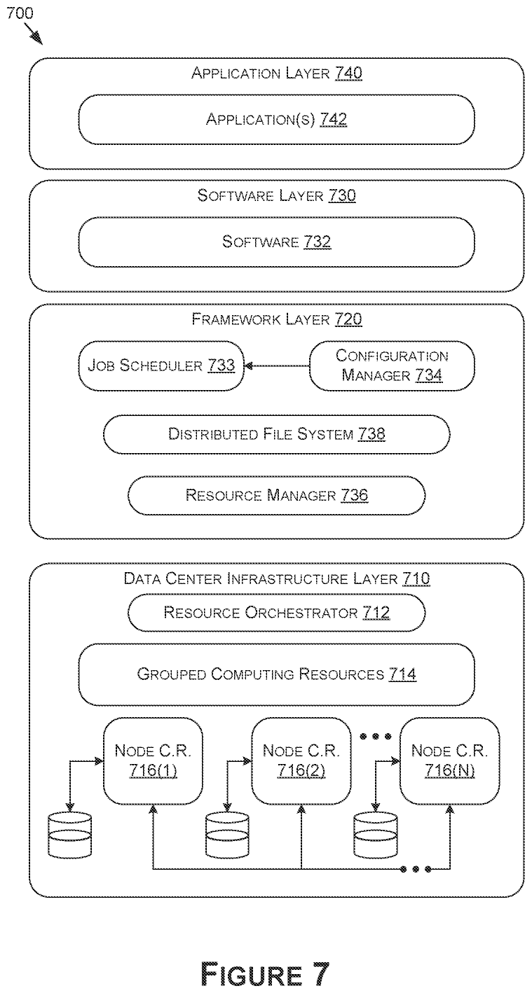

With reference to FIG. 1, FIG. 1 depicts an example human feature detection pipeline 100 with validity checks, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 500 of FIGS. 5A-5D, example computing device 600 of FIG. 6, and/or example data center 700 of FIG. 7.

In the embodiment illustrated in FIG. 1, the human feature detection pipeline 100 includes sensor(s) 105, human feature detector(s) 110, a validity check component 120, and a control component 170. At a high level, the sensor(s) 105 may be used to generate sensor data representing an environment, and the human feature detector(s) 110 may comprise one or more machine learning models that detect, monitor, and/or track any suitable human feature of one or more humans represented in the sensor data. The validity check component 120 may apply one or more validity checks (e.g., that model one or more aspects of human physiology) to frames of the detected human features to detect the presence of faults, and the control component 170 may take some responsive action in response to detection of a fault.

The sensor(s) 105 may include any number and/or any type of sensor, such as, without limitation, one or more cameras, LiDAR sensors, RADAR sensors, and/or other sensor types such as those described below with respect to the autonomous vehicle 500 of FIGS. 5A-5D. Generally, the sensor(s) 105 may be positioned to observe one or more humans and/or an environment in which one or more humans may be present, and may be used to generate frames of sensor data (e.g., images) at any suitable frame rate. In some embodiments, the sensor(s) 105 may include one or more sensors of an ego-machine positioned for interior or exterior sensing (e.g., an OMS or DMS camera such as the OMS sensor(s) 501 of the vehicle 500, a surround view camera such as the surround camera(s) 574 of the vehicle 500), and the sensor(s) 105 may be used to generate frames of sensor data that represent an environment being monitored (e.g., an environment outside the ego-machine, an interior space, an operator or occupant of an ego-machine, some other monitored subject).

In some embodiments, the sensor(s) 105 may comprise one more sensors (e.g., cameras) of a monitoring system such as an OMS. In an example in-cabin or cockpit monitoring system such as a vehicle OMS, one or more optical sensors may be positioned to observe a scene within the cabin, cockpit, or other interior space. An OMS may comprise a DMS, a system that monitors non-driver occupants, or a system that monitors driver occupant(s) and/or non-driver occupant(s). OMSs often rely on observations from multiple optical sensors (e.g., RGB sensors, infrared IR sensors, depth sensors, cameras, etc.) positioned at various locations throughout a vehicle interior. Vehicle manufacturers tend to vary the number of OMS cameras from model to model and depending on the trim level. Base models usually have one camera facing the driver (e.g., positioned within a steering column, vehicle pillar, or infotainment console). Higher trim levels may include any number of additional cameras (e.g., one in the steering column facing the driver, one in the rear review mirror facing the driver or the cabin, one in a vehicle pillar facing a particular row of seating, one above a row of headrests facing forward for child detection, etc.). Generally, occupant and/or driver monitoring systems may include any number of cameras (e.g., 4 DMS cameras and 16 OMS cameras) positioned throughout a vehicle interior. These are just a few examples of possible sensor layouts, and other sensor layouts within any suitable space may be implemented within the scope of the present disclosure.

Any or all of the sensor(s) 105 may be used to generate a frame of sensor data (e.g., an image generated using each of one or more OMS cameras) for each time slice (e.g., at a particular frame rate, such as 30 frames per second (fps)), and the frame of sensor data for each time slice may be used by the human feature detector(s) 110 to detect, monitor, and/or track one or more human features represented in the sensor data.

The human feature detector(s) 110 may comprise one or more of any type of machine learning model that detects, monitors, and/or tracks any suitable human feature (e.g., keypoint(s), gaze, pose, drowsiness, gesture, joint angle, limb length, shape, presence, etc.). Taking an example embodiment involving an OMS, the human feature detector(s) 110 may be used within a vehicle cabin to perform hands-on-wheel detection, 3D pose estimation, monocular depth estimation, child presence detection, and/or other real-time assessments of occupant and/or operator presence, gaze, alertness, and/or other human features. In some embodiments, the human feature detector(s) 110 may be implemented using one or more corresponding deep neural networks (DNNs), such as a convolutional neural network (CNN) or transformer neural network (TNN). Although certain embodiments are described with the human feature detector(s) 110 and other machine learning models described herein being implemented using neural network(s), this is not intended to be limiting. For example, and without limitation, the human feature detector(s) 110 may include any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), Hopfield, Boltzmann, deep belief, de-convolutional, generative adversarial, liquid state machine, etc.), and/or other types of machine learning models.

The human feature detector(s) 110 may extract any suitable representation of one or more human features. In some embodiments, the human feature detector(s) 110 extracts 2D and/or 3D locations of one or more detected human keypoints representing anatomical landmarks or joints (e.g., facial landmarks such as the eyes, nose, mouth, and eyebrows; joints such as the shoulders, elbows, wrists, hips, knees, and ankles; and/or other anatomical landmarks) using any known technique. In some embodiments, the one or more detected human keypoints may be used to derive one or more detected human features (e.g., gaze, pose, drowsiness, gesture, joint angle, limb length, etc.), and/or the human feature detector(s) 110 may be used to directly detect those human features without the use of keypoints as an intermediate step. Generally, any known technique may be used to detect any type and number of human feature.

The validity check component 120 may apply one or more validity checks to frames of the detected human features to detect the presence of faults. For example, the validity check component 120 may include a kinematics constraint component 130, an anatomical constraint component 140, a spatial constraint component 150, and/or a cross-consistency component 160.

The kinematics constraint component 130 may execute one or more validity checks modeled on the kinematics of human motion. For example, temporal consistency and/or quantifiable limits on the anticipated velocity or acceleration of human joints (which may depend on the application) may impose constraints on plausible locations of a person, a part of their body, and/or a representation thereof (e.g., a human keypoint, a detected gesture or pose, etc.) in any given time slice. Taking an application in which the human feature detector(s) 110 monitor a driver's face as an example, at any given frame rate, the driver should not be able to rotate their head more than some angular threshold (e.g., 45 degrees) or move their head by more than some displacement threshold (e.g., 50 centimeters) from frame to frame (e.g., in 66 milliseconds at 15 fps). As such, the kinematics constraint component 130 may compute a change in 2D or 3D position (spatial displacement) of one or more detected human features (e.g., position of one or more detected human keypoints, position of a reference point of a detected pose or gesture, etc.) from frame to frame, and apply a corresponding threshold to determine whether or not the change is plausible. Additionally or alternatively, the kinematics constraint component 130 may compute a change in one or more joint angles (angular displacement) represented by one or more detected human features (e.g., detected human keypoints, a detected pose or gesture, etc.) from frame to frame, and apply a corresponding threshold to determine whether or not the change is plausible. Generally, one or more limits on expected keypoint, joint, and/or pose velocity and/or acceleration may be used to derive a corresponding threshold change in (e.g., keypoint) 2D or 3D position, joint (e.g., elbow, knee, shoulder, wrist, ankle, etc.) angle, and/or otherwise. The human feature detector(s) 110 may detect 2D pixel positions and/or 3D positions of human keypoints or poses from each frame of sensor data, and the kinematics constraint component 130 may compute and monitor one or more keypoint or pose changes from frame to frame (e.g., changes in 2D and/or 3D position, change in joint angle). As such, the kinematics constraint component 130 may generate an indication that a change in detected keypoint or pose exceeding a designated threshold based on body kinematics is considered to be a fault or error.

The anatomical constraint component 140 may execute one or more validity checks modeled on anatomical constraints the human body imposes on joint angles and/or plausible limb lengths. For example, some joints like elbows and knees cannot move in all directions. Knees may be able to extend to about 0 degrees when fully straightened, and may bend up to 135 or 140 degrees. Elbows may be able to extend to about 0 degrees when fully straightened, and may bend up to 145 or 160 degrees. As such, the human feature detector(s) 110 may detect and/or compute one or more joint angles, and the anatomical constraint component 140 may apply a designated threshold representing one or more limits on the expected range of motion for one or more joints to the detected joint angle(s) and generate an indication that a detected joint angle exceeding a designated threshold is considered to be a fault or error.

In some embodiments, limb lengths in human occupants may be modeled within a finite expected range, the human feature detector(s) 110 may detect and/or compute estimated lengths of one or more limbs (e.g., from a 3D model representing a detected pose of an occupant), a combination of limbs (e.g., height, wingspan, etc.), and/or otherwise, and the anatomical constraint component 140 may apply a designated threshold representing one or more limits on the expected range of length for one or more detected limb lengths. In some embodiments, the human feature detector(s) 110 may apply any known age estimation technique to estimate an age or age range of a detected person, and may use the estimated age to estimate limb length. For example, the anatomical constraint component 140 may encode an anthropomorphic chart that maps age ranges to corresponding lengths of one or more limbs and/or a combination of limbs, such that the anatomical constraint component 140 may use the encoded anthropomorphic chart to identify one or more limits on an expected limb length(s). As such, the human feature detector(s) 110 may detect and/or compute one or more estimated limb lengths, and the anatomical constraint component 140 may apply a designated threshold representing one or more limits on the expected length of one or more detected limbs and generate an indication that a detected limb length exceeding a designated threshold is considered to be a fault or error.

Additionally or alternatively to limits on absolute limb length detected from a particular frame, detected limb length may be expected not to change substantially from frame to frame (e.g., in the absence of seating changes), so a threshold may be derived for a maximum expected change in detected limb length from frame to frame. As such, the human feature detector(s) 110 may detect and/or compute changes to one or more estimated limb lengths (e.g., from frame to frame), and the anatomical constraint component 140 may apply a designated threshold representing one or more limits on the expected change in length of one or more detected limbs and generate an indication that a detected change in limb length exceeding a designated threshold is considered to be a fault or error.

In some embodiments, one or more validity checks may be modeled on spatial constraints the human body imposes on relative 2D and/or 3D positions of detected keypoints and/or corresponding poses. For example, superposition of certain keypoints is impossible (e.g., the hand or neck cannot be inside the torso). As such, the human feature detector(s) 110 may detect and/or compute relative 2D or 3D positions of designated detected body parts (e.g., represented by detected keypoints, a detected pose or gesture), and the anatomical constraint component 140 may apply a designated threshold representing one or more limits on the relative 2D or 3D positions and generate an indication that relative 2D or 3D positions of detected body parts exceeding a designated threshold is considered to be a fault or error.

The spatial constraint component 150 may execute one or more validity checks modeled on spatial constraints such as those that are external to the human body. In some embodiments, one or more spatial constraints may be derived from a monitored context. In a DMS, for example, the driver should be sitting in a seat, so the knee joint should not typically be able to extend to a fully straightened position. While driving, depending on the design on the vehicle, chair position, and/or other considerations, the driver's knee joint may be able to extend up to 45 degrees (e.g., when operating pedals) and may bend up to 90 or 120 degrees. Other physical contexts may have other anticipated spatial constraints. As such, corresponding thresholds in 2D or 3D positions of, distance between, and/or angle represented by corresponding detected keypoints or poses may be derived. As such, the human feature detector(s) 110 may detect and/or compute 2D or 3D positions of one or more detected body parts (e.g., represented by detected keypoints, a detected pose or gesture), distance between 2D or 3D positions of one or more detected body parts and some spatial constraint (e.g., a wall), and/or one or more joint angles. Accordingly, the spatial constraint component 150 may apply a designated threshold to one or more of the foregoing and generate an indication that a detected body part position and/or joint angle exceeding a designated threshold imposed by one or more spatial constraints that are external to the human body is considered to be a fault or error.

The cross-consistency component 160 may execute one or more validity checks modeled on consistency across detection modalities. For example, the sensor(s) 105 may comprise multiple cameras (e.g., a DMS and OMS camera) used to monitor the same person, the human feature detector(s) 110 may comprise and use different feature detectors for the different cameras to detect one or more aspects of the same human feature. For example, the human feature detector(s) 110 may detect multiple instances of (e.g., 3D) positions of corresponding keypoints using image data generated by the different cameras, and the cross-consistency component 160 may verify one instance against the other by applying a designated threshold to the difference in detected (e.g., 3D) position of one or more detected body parts (e.g., represented by one or more detected keypoints, a detected pose or gesture). As such, the cross-consistency component 160 may generate an indication that a difference in a detected body part position across detection modalities exceeding a designated threshold is considered to be a fault or error in either or both processing pipelines.

Generally, cross checks may be performed across concurrent human monitoring systems (e.g., the cross-consistency component 160 may cross-check a face detect from a DMS against a face or person detect from an OMS), and/or between a human monitoring system and a non-human monitoring system (e.g., the cross-consistency component 160 may cross check a detected change in steering angle against a detected hand gesture representing a classification that both hands are off the steering wheel). In another example, the sensor(s) 105 may comprise one or more RADAR sensor(s), the human feature detector(s) 110 may detect body pose or movement from RADAR data generated using the RADAR sensor(s), and the cross-consistency component 160 may correlate a position or change in the detected body pose with a corresponding position or change in body pose detected by a DMS or OMS. These are just a few examples, and other types of cross-checks across detection modalities are contemplated within the scope of the present disclosure.

Although some embodiments have been described as computing differences from one frame to the next, generally, the validity check component 120 may compute changes in detected human features over any number of frames. As such, if the validity check component 120 determines that a particular detected human feature includes an error or fault (and/or a corresponding one of the human feature detector(s) 110 has generated an error or fault), the validity check component 120 may provide the control component 170 with an indication that the error or fault has occurred. As such, the control component 170 may take any suitable responsive action, which may depend on the application and/or embodiment. For example, the control component 170 may initiate a notification to the relevant personnel or administrators, generate a log entry capturing relevant information (e.g., timestamp, a representation of the nature of the error or fault, system state, etc.), trigger one or more predefined corrective actions (e.g., temporarily disabling specific functionalities, rerouting tasks to redundant or alternative components that provide similar functionality, adjusting parameters to mitigate the impact of the fault or error), trigger one or more predefined self-healing actions (e.g., reinitializing or restarting a component or process), and/or other actions. Generally, the computer vision task and responsive action may depend on the implementation.

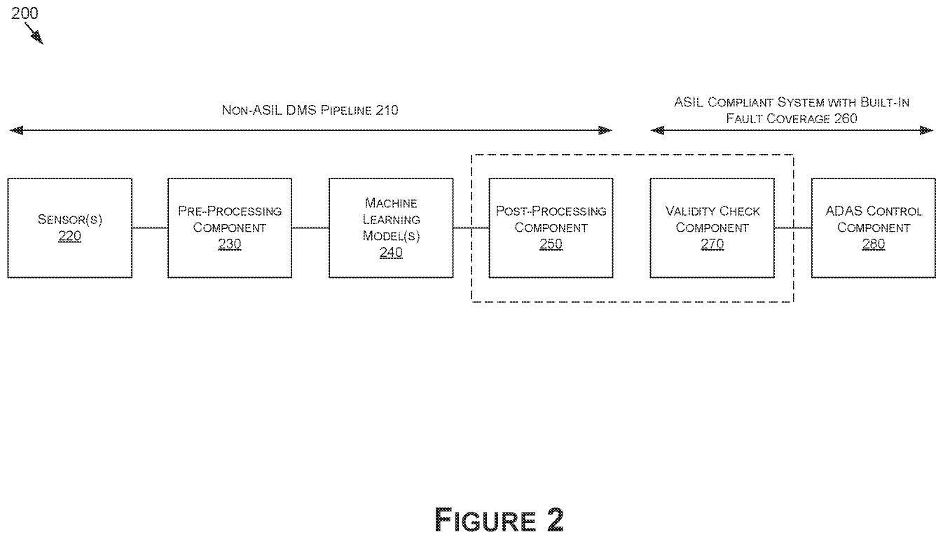

For example, in some embodiments, the present techniques may be used in an advanced driver assistance control system comprising a DMS that controls activation, operation, and/or deactivation of one or more ADAS features (e.g., L2 or L3 autonomous driving). FIG. 2 is a data flow diagram illustrating an example advanced driver assistance control system 200 with validity checks, in accordance with some embodiments of the present disclosure. In an example implementation, a DMS that controls activation, operation, and/or deactivation of certain L2 systems works in conjunction with those systems to achieve ASIL-B safety goals, and a DMS that controls L3 systems works in conjunction with those systems to achieve ASIL-D safety goals. In contrast to conventional techniques that implement these DMSs on ASIL-rated hardware, FIG. 2 illustrates an embodiment in which a DMS is implemented on non-ASIL-rated hardware (e.g., the non-ASIL DMS pipeline 210), and one or more validity checks and the ADAS are executed ASIL-rated hardware (e.g., the ASIL compliant system 260 with built-in fault coverage). Generally, the DMS algorithm implemented by the non-ASIL DMS pipeline 210 may be robust to non-persistent faults (e.g., the machine learning model(s) 240 typically learn to ignore individual pixel errors), and the one or more validity checks that run on ASIL-rated hardware may serve to detect persistent faults in the DMS output, thereby satisfying ASIL requirements for fault tolerance and diagnostic coverage and enabling one or more components of the DMS to run on non-ASIL-rated hardware.

Generally, the non-ASIL DMS pipeline 210 may implement any known DMS technique. In the embodiment illustrated in FIG. 2, the non-ASIL DMS pipeline 210 includes sensor(s) 220, a pre-processing component 230, machine learning model(s) 240, and a post-processing component 250. At a high level, the sensor(s) 220 may include any number and type of sensor (e.g., camera) that captures a visual or structural representation of the driver and/or their surroundings. The pre-processing component 230 may prepare raw sensor data (e.g., image data) from the sensor(s) 220 for analysis by the machine learning model(s) 240, which may extract an encoded representation of any number and type of human feature (e.g., keypoint(s), head pose, gaze direction, blink state, driver attentiveness, hand position, limb length, joint angle, gesture(s), age, etc.). As such, the post-processing component 250 may decode the extracted human feature(s) to generate a representation of one or more detected driver behaviors and/or driver states.

More specifically, the sensor(s) 220 may include any number and type of sensor, such as, without limitation, one or more cameras, RADAR sensors, LiDAR sensors, and/or other sensor types, such as the OMS sensor(s) 501 of the autonomous vehicle 500 of FIGS. 5A-D or some other ego-machine. The sensor(s) 220 (e.g., cameras, RGB sensors, infrared (IR) sensors, depth sensors such as RADAR sensors, etc.) may be positioned within an interior space (e.g., a cabin or cockpit) to observe an operator of the ego-machine.

Generally, the pre-processing component 230 may prepare raw sensor data (e.g., image data) from the sensor(s) 220 into a format that is compatible with the machine learning model(s) 240. Any or all of the sensor(s) 220 may be used to generate a frame of sensor data (e.g., image data, RADAR data, etc.) for each time slice (e.g., at a particular frame rate, such as 30 frames per second (fps)), and the pre-processing component 230 may apply the frame of sensor data for each time slice as an input to a corresponding machine learning model(s) 240. In some embodiments, the pre-processing component 230 may apply any known noise reduction, image (or other sensor data) enhancement, and/or normalization technique prior to applying the resulting processed sensor data to a corresponding machine learning model(s) 240.

In some embodiments, the pre-processing component 230 may stack sensor data (e.g., image data, projected RADAR or LIDAR data) from any number and type of sensor into corresponding channels of an input tensor. In some embodiments, the pre-processing component 230 may split an RGB image into its constituent color channels and used the color channels as corresponding channels of an input tensor. Additionally or alternatively, the pre-processing component 230 may stack different images (e.g., images captured by different cameras, a sequence or time-series of images captured over time, etc.) into corresponding channels of an input tensor. In some embodiments, the pre-processing component 230 may use RGB and IR images generated using an RGB-IR camera or separate RGB and IR cameras (whether sampled at the same rate or at different rates), for example, by stacking the RGB and IR images into corresponding input channels, by selecting one of the image types based on some criterion (e.g., use RGB images during the day or in the presence of a threshold amount of detected lighting, use IR images otherwise).

In some embodiments, the sensor(s) 220 may include one or more RADAR sensors used to generate RADAR data (e.g., a serialized or encoded point cloud, a point cloud projected onto a 2D image such as a range image or a top down image), and the pre-processing component 230 may encode reflection characteristics of detected points in corresponding channels of an input tensor and/or accumulate RADAR data over some duration or number of spins. In some embodiments, the pre-processing component 230 may temporally align sensor data from different sensors and/or different types of sensors to identify and select sensor data representing substantially the same time slice, and combine the different types of sensors in corresponding channels of an input tensor. These are meant simply as examples, and other techniques may additionally or alternatively be applied to prepare sensor data for feature extraction. As such, the pre-processing component 230 may apply the prepared sensor data to the machine learning model(s) 240.

The machine learning model(s) 240 may include any number and type of machine learning model, which may extract an encoded representation of any number and type of human feature (e.g., keypoint(s), head pose, gaze direction, blink state, driver attentiveness, hand position, limb length, joint angle, gesture(s), age, etc.). In some embodiments, any or all of the machine learning model(s) 240 may be implemented using a deep neural network (DNN), such as a convolutional neural network (CNN), transformer neural network (TNN), or other machine learning model

Generally, the machine learning model(s) 240 may use any known technique to execute any number of computer vision tasks. In some embodiments, the machine learning model(s) 240 may extract a representation of various human keypoints, and the post-processing component 250 may use the extracted keypoints to derive one or more human features (e.g., head pose, gaze direction, blink state, driver attentiveness, hand position, limb length, joint angle, gesture(s), age, etc.). Additionally or alternatively, the machine learning model(s) 240 may extract an encoded representation that directly assesses one or more human features without the use of keypoints, and the post-processing component 250 may decode the one or more human features from the model(s) output. Generally, the machine learning model(s) 240 and/or the post-processing component 250 may extract, decode, quantify, and/or otherwise assess any human feature, for example, by tracking facial features to assess head pose, gaze direction, and/or eye closure; extracting eye movement patterns; monitoring for signs of drowsiness or distraction; performing hands-on-wheel detection, monitoring head movement to assess driver attentiveness and engagement with the road; detecting facial expressions to recognize emotions such as stress or frustration; using voice recognition to assess speech patterns and detect signs of fatigue or impairment based on the driver's voice; and/or other techniques. As such, the post-processing component 250 may generate a representation of one or more extracted human features representing one or more detected driver (or other operator) behaviors and/or states.

In some embodiments, the ASIL compliant system 260 may execute one or more validity checks to test the plausibility of the one or more extracted human features that were generated by the non-ASIL DMS pipeline 210. In the embodiment illustrated in FIG. 2, the ASIL compliant system 260 includes a validity check component 270 that executes the validity check(s) and an ADAS control component 280 that controls the activation, operation, and/or deactivation of one or more ADAS features based on the validity check(s). The validity check component 270 and the ADAS control component 280 may, but need not, run on the same chip or other hardware component. For example, both components may be implemented on the same System on Chip (SoC). In another example, the validity check component 270 may be implemented on a microcontroller connected to an SoC that implements the ADAS control component 280.

The validity check component 270 may perform one or more validity checks on the one or more human features extracted by the non-ASIL DMS pipeline 210. Generally, the validity check component 270 may perform any of the validity checks described herein (such as those described with reference to the kinematics constraint component 130, the anatomical constraint component 140, the spatial constraint component 150, and/or the cross-consistency component 160 of FIG. 1), and/or others. For example, the validity check component 270 may apply a designated threshold representing one or more limits on an expected range of motion for one or more components of a detected head pose (e.g., pitch, yaw, roll) and/or gaze direction (e.g., theta, phi), one or more limits on expected changes in a detected head pose and/or gaze direction (e.g., from frame to frame, using some statistical technique such as an exponentially weighted moving average to average values in a window), one or more limits on an expected duration of time between detected blinks (e.g., no more than one minute between detected blinks), one or more limits on expected changes in a detected measure of drowsiness (e.g., KSS), one or more limits on an expected range of motion or velocity of some other detected human feature (e.g., eye movement, head nodding, mouth or lip movement, hand position, etc.), and/or others. In some embodiments, the validity check component 270 may generate some statistical measure (e.g., average, median) of a detected human feature over some window (e.g., some number of frames, duration of time), and may apply a corresponding validity check on the statistical measure. As such, the validity check component 270 may perform one or more validity checks to detect the presence of errors or faults in the one or more human features extracted by the non-ASIL DMS pipeline 210, and provide an indication of the presence of a detected error or fault to the ADAS control component 280.

Generally, the ADAS control component 280 may be part of an ADAS system such as the ADAS system 538 of FIG. 5C. More specifically, the ADAS control component 280 may coordinate and/or manage one or more functions within the ADAS system. Generally, the ADAS system may use any known technique to assess the vehicle's surroundings, identify potential risks or hazards, and implement autonomous driving features such as adaptive cruise control, automatic emergency braking, lane-keeping assistance, and collision avoidance systems, to name a few examples. Unlike prior techniques, if the validity check component 270 detects an error or fault in one or more human features extracted by the non-ASIL DMS pipeline 210, the ADAS control component 280 may deem (e.g., one or more corresponding components of) the non-ASIL DMS pipeline 210 to be inoperative, and the ADAS control component 280 may trigger one or more responsive actions. For example, the ADAS control component 280 may trigger the ADAS system to disengage autonomous driving, provide some advanced warning (e.g., 10 seconds) prior to disengaging autonomous driving, trigger the ADAS system to execute one or more emergent driving maneuvers (e.g., the autonomous vehicle may perform an emergency stop), and/or other actions.

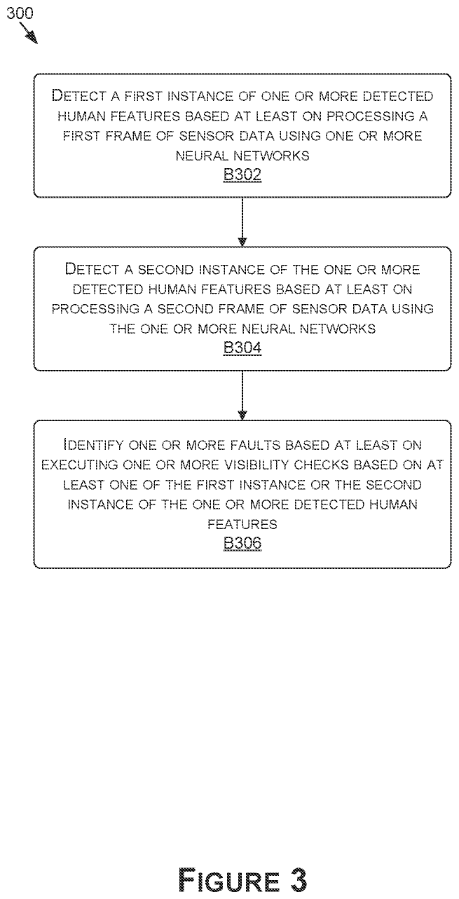

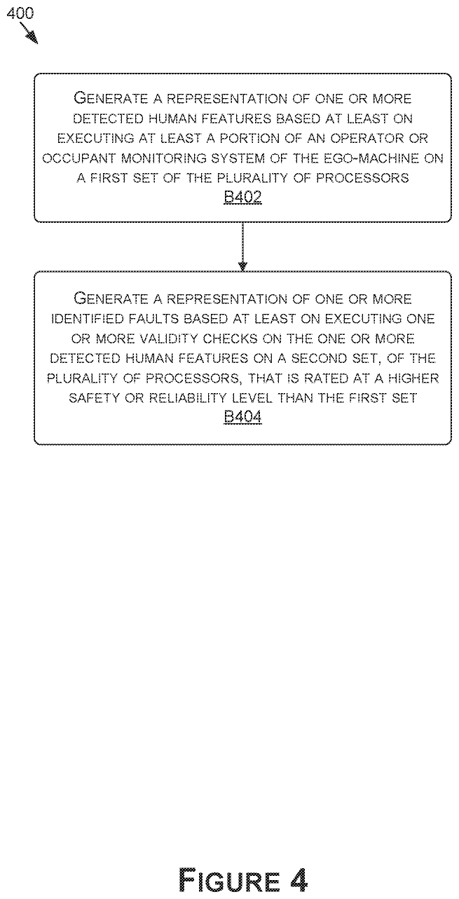

Now referring to FIGS. 3 and 4, each block of the methods 300 and 400, described herein, comprises a computing process that may be performed using any combination of hardware, firmware, and/or software. For instance, various functions may be carried out by a processor executing instructions stored in memory. The methods 300 and 400 may also be embodied as computer-usable instructions stored on computer storage media. The methods 300 and 400 may be provided by a standalone application, a service or hosted service (standalone or in combination with another hosted service), or a plug-in to another product, to name a few. In addition, the methods 300 and 400 are described, by way of example, with respect to the human feature detection pipeline 100 of FIG. 1 and/or the advanced driver assistance control system 200 of FIG. 2. However, these methods may additionally or alternatively be executed by any one system, or any combination of systems, including, but not limited to, those described herein.

FIG. 3 is a flow diagram showing a method 300 for identifying faults based at least on one or more validity checks, in accordance with some embodiments of the present disclosure. The method 300, at block B302, includes detecting a first instance of one or more detected human features based at least on processing a first frame of sensor data using one or more neural networks, and the method 300, at block B304, includes detecting a second instance of the one or more detected human features based at least on processing a second frame of sensor data using the one or more neural networks. For example, with respect to the human feature detection pipeline 100 of FIG. 1, the sensor(s) 105 may be used to generate sensor data representing an environment, and the human feature detector(s) 110 may comprise one or more machine learning models that detect, monitor, and/or track any suitable human feature (e.g., keypoint(s), gaze, pose, drowsiness, gesture, joint angle, limb length, shape, presence, etc.) of one or more humans represented in the sensor data.

The method 300, at block B306, includes identifying one or more faults based at least on executing one or more validity checks based on at least one of the first instance or the second instance of the one or more detected human features. For example, with respect to the human feature detection pipeline 100 of FIG. 1, the validity check component 120 may apply one or more validity checks (e.g., that model one or more aspects of human physiology) to frames of the detected human features to detect the presence of faults (e.g., checks on individual frames, checks on changes from one frame to another). For example, the kinematics constraint component 130 may execute one or more validity checks modeled on the kinematics of human motion, the anatomical constraint component 140 may execute one or more validity checks modeled on anatomical constraints the human body imposes on joint angles and/or plausible limb lengths, the spatial constraint component 150 may execute one or more validity checks modeled on spatial constraints such as those that are external to the human body, and the cross-consistency component 160 may execute one or more validity checks modeled on consistency across detection modalities.

FIG. 4 is a flow diagram showing a method 400 for executing one or more validity checks on a set of safety or reliability rated processor(s), in accordance with some embodiments of the present disclosure. The method 400, at block B402, includes generating a representation of one or more detected human features based at least on executing at least a portion of an operator or occupant monitoring system of the ego-machine on a first set of the plurality of processors. For example, with respect to the advanced driver assistance control system 200 of FIG. 2, the non-ASIL DMS pipeline 210 may generate a representation of one or more extracted human features (e.g., head pose, gaze direction, blink state, driver attentiveness, hand position, limb length, joint angle, gesture(s), age, etc.) representing one or more detected driver or other operator behaviors and/or states.

The method 400, at block B404, includes generating a representation of one or more identified faults based at least on executing one or more validity checks on the one or more detected human features on a second set, of the plurality of processors, that is rated at a higher safety or reliability level than the first set. For example, with respect to the advanced driver assistance control system 200 of FIG. 2, the ASIL compliant system 260 may execute one or more validity checks on the one or more extracted human features in the non-ASIL DMS pipeline 210.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Autonomous Vehicle

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), one or more occupant monitoring system (OMS) sensor(s) 501 (e.g., one or more interior cameras), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

Cameras with a field of view that include portions of the interior environment within the cabin of the vehicle 500 (e.g., one or more OMS sensor(s) 501) may be used as part of an occupant monitoring system (OMS) such as, but not limited to, a driver monitoring system (DMS). For example, OMS sensors (e.g., the OMS sensor(s) 501) may be used (e.g., by the controller(s) 536) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D).

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(D) (collectively referred to herein as PCIe switches 582), and/or CPUs 580(A)-580(B) (collectively referred to herein as CPUs 580). The GPUs 584, the CPUs 580, and the PCIe switches may be interconnected with high-speed interconnects such as, for example and without limitation, NVLink interfaces 588 developed by NVIDIA and/or PCIe connections 586. In some examples, the GPUs 584 are connected via NVLink and/or NVSwitch SoC and the GPUs 584 and the PCIe switches 582 are connected via PCIe interconnects. Although eight GPUs 584, two CPUs 580, and two PCIe switches are illustrated, this is not intended to be limiting. Depending on the embodiment, each of the server(s) 578 may include any number of GPUs 584, CPUs 580, and/or PCIe switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising one or more processing units to:
detect one or more first positions of one or more human keypoints based at least on processing a first frame of sensor data using one or more neural networks;
detect one or more second positions of the one or more human keypoints based at least on processing a second frame of sensor data using the one or more neural networks; and
generate a representation of one or more identified faults based at least on executing one or more validity checks based on at least one of the one or more first positions or the one or more second positions of the one or more human keypoints.

2. The one or more processors of claim 1, wherein the one or more processing units are further to execute the one or more validity checks based at least on comparing a designated threshold to a spatial displacement of the one or more human keypoints from the one or more first positions to the one or more second positions.

3. The one or more processors of claim 1, wherein the one or more processing units are further to execute the one or more validity checks based at least on applying a designated threshold to an angular displacement of a joint represented by a plurality of human keypoints comprising the one or more human keypoints from a plurality of first positions comprising the one or more first positions to a plurality of second positions comprising the one or more second positions.

4. The one or more processors of claim 1, wherein the one or more processing units are further to execute the one or more validity checks based at least on applying a designated threshold to a difference between a detected limb length represented by a plurality of human keypoints comprising the one or more human keypoints at a plurality of first positions comprising the one or more first positions and at a plurality of second positions comprising the one or more second positions.

5. The one or more processors of claim 1, wherein the one or more processing units are further to execute the one or more validity checks based at least on applying a designated threshold to a detected joint angle represented by at least one of: a plurality of human keypoints comprising the one or more human keypoints at a plurality of first positions comprising the one or more first positions, or the plurality of human keypoints at a plurality of second positions comprising the one or more second positions.

6. The one or more processors of claim 1, wherein the one or more processing units are further to execute the one or more validity checks based at least on applying a designated threshold to a detected limb length represented by at least one of: a plurality of human keypoints comprising the one or more human keypoints at a plurality of first positions comprising the one or more first positions, or the plurality of human keypoints at a plurality of second positions comprising the one or more second positions.

7. The one or more processors of claim 1, wherein the one or more processing units are further to execute the one or more validity checks based at least on applying a designated threshold associated with one or more spatial constraints that are external to a human body represented by the one or more human keypoints.

8. The one or more processors of claim 1, wherein the one or more processing units are further to execute the one or more validity checks based at least on applying a designated threshold on relative positions of keypoints within a detected instance of a plurality of human keypoints comprising the one or more human keypoints.

9. The one or more processors of claim 1, wherein first frame represents a first modality of sensor data from a first time slice, the second frame represents a second modality of sensor data from the first time slice, and the one or more processing units are further to execute the one or more validity checks based at least on applying a designated threshold to a spatial displacement of the one or more human keypoints from the one or more first positions detected using the first modality of sensor data from the first time slice to the one or more second positions detected using the second modality of sensor data from the first time slice.

10. The one or more processors of claim 1, wherein the one or more processing units are further to execute the one or more validity checks on first hardware rated for a first safety or reliability level, and to execute the one or more neural networks on second hardware that is unrated or rated for a lower safety or reliability level than the first safety or reliability level.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processing units to generate a representation of one or more detected human keypoints based at least on processing sensor data using one or more neural networks, and to detect one or more errors based at least on executing one or more validity checks on the one or more detected human keypoints.

13. The system of claim 12, wherein the one or more processing units are further to execute the one or more validity checks based at least on applying a designated threshold to a spatial displacement of the one or more detected human keypoints or an angular displacement of a joint represented by a plurality of detected human keypoints comprising the one or more detected human keypoints.

14. The system of claim 12, wherein the one or more processing units are further to execute the one or more validity checks based at least on applying a designated threshold to a difference between a detected limb length represented by a plurality of detected human keypoints comprising the one or more detected human keypoints at a plurality of first detected positions and at a plurality of second detected positions.

15. The system of claim 12, wherein the one or more processing units are further to execute the one or more validity checks based at least on applying a designated threshold to a detected joint angle or a detected limb length represented by a plurality of detected human keypoints comprising the one or more detected human keypoints.

16. The system of claim 12, wherein the one or more processing units are further to execute the one or more validity checks based at least on applying a designated threshold.

17. The system of claim 12, wherein the one or more processing units are further to execute the one or more validity checks on first hardware rated for a first safety or reliability level, and to execute the one or more neural networks on second hardware rated for a lower safety or reliability level than the first safety or reliability level.

18. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
detecting a first instance of one or more detected human features based at least on processing a first frame of sensor data using one or more neural networks;
detecting a second instance of the one or more detected human features based at least on processing a second frame of sensor data using the one or more neural networks; and
identifying one or more faults based at least on executing one or more validity checks based on at least one of the first instance or the second instance of the one or more detected human features.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.
